(19) United States
(12) Patent Application Publication
(10) Pub. No.: US 2009/0216944 A1
(43) Pub. Date: Aug. 27, 2009

(54) EFFICIENT VALIDATION OF WRITES FOR PROTECTION AGAINST DROPPED WRITES

(75) Inventors: Binny Sher Gill, Auburn, MA (US); James Lee Hafner, San Jose, CA (US)

Correspondence Address: Gregory Smith, 3900 Newpark Mall Road, Suit 317, Newark, CA, 94560, US

(73) Assignee: International Business Machines Corporation, Armonk, NY (US)

(21) Appl. No.: 12/036,194

(22) Filed: Feb. 22, 2008

(51) Int. Cl. G06F 12/00; G06F 12/08

(52) U.S. Cl. 711/113; 711/112; 711/E12.001; 711/E12.019

(57) ABSTRACT

A write cache provides for staging of data units written from a processor for recording in a disk. The order in which destages and validations occur is controlled to make validations more efficient. The data units are arranged in a circular queue according to their respective disk storage addresses. Each data unit is tagged with a state value of 1, 0, or −1. A destaging pointer is advanced one-by-one to each data unit like the hand of a clock. Each data unit pointed to is evaluated as a destage victim. The first step is to check its state value. A data unit newly brought into the write cache will have its state value reset to 0. It will stay that way until it receives an overwrite x command or the destage pointer clocks around to x. If an overwrite x, the state value is set to 1, in a way, indicating recent use of the data unit and postponing its destaging and eviction. If the destage pointer clocks around to x when the state was 0, then it's time to destage x and the state value is changed to −1. A write to the disk occurs and a later read will be used to verify the write. If the state value was already 1 when the destage pointer clocks around to x, the state value is reset to 0. If the destage pointer clocks around to x when the state is −1, the associated data is read from the disk and validated to be same as the copy in cache. If not, the destage of x is repeated, and the state value remains as −1. Otherwise, if the associated read for validation did return a success, then data unit x is evicted from the write cache.

### FIELD OF THE PRESENT INVENTION

The present invention relates to computer data storage, and in particular to reducing read and write latencies in disk systems equipped with write caches that verify each write to detect and repair dropped writes.

### BACKGROUND

Computers tend to access program and data memory non-evenly, some memory addresses are favored and accessed more frequently. The more expensive semiconductor types of memory can be accessed more rapidly than magnetic media types, thus keeping the computer waiting at idle less during the access. But the really fast memory devices, like those used for cache memory, are too expensive to be practical for use as the whole memory and data space. Optical and magnetic disk and tape storage is much slower to access, but are very attractive because their cost per byte of storage are exceedingly low, as compared to semiconductor memory systems.

The best balance between performance and system cost generally means using a combination of cache memory, main random access memory (RAM), and disk/tape storage. System performance will thus be the least adversely impacted if the program and data that need to be accessed the most frequently are kept available in the cache memory.

The benefits of cache memory work both ways, for write cycles as well as read cycles. A cache hit on a write cycle can be far more beneficial than a cache hit on a read cycle because writing a data block can require an initial access to write the data, another access to read back and verify the write, and another to update the parity or check bits. Each access involves a latency for the heads to seek the tracks, and another latency for the tracks to spin to the correct sector under the heads. A read miss needs only one access, and these will compete with the write cycle accesses, if any.

Write caches in fast, non-volatile storage used in modern storage controllers can hide write latencies. Effective methods of write cache management are important to overall system performance. In read-modify-write and parity updates, each write may cause up to four separate disk seeks, while a read miss can cause only a single disk seek. Write caches are usually much smaller in size than read caches, 1:16 is typical.

The contents of a write cache can be destaged in any desired order without being concerned about starving any write requests, due to the asynchronous nature. As long as non-volatile storage (NVS) is drained at a sufficiently fast rate, the precise order in which the NVS contents are destaged will not affect fast write performance. But, how and what is destaged can affect the peak write throughput and concurrent read performance.

The capacity of disks to support sequential or nearly sequential write traffic is significantly higher than their capacity to support random writes, and, hence, destaging writes while exploiting this physical fact can significantly improve the peak write throughput of the system. Write caching algorithms leverage sequentially or spatial locality to improve the write throughput and the aggregate throughput of the system.

Any writes being destaged will compete with concurrent reads for use of the disk head. Writes represent a background load on the disks and indirectly increase read response times and reduce read throughput. The less the response time needed for reads, the less the writes will be obstructed.

A write caching policy must decide what data to destage. To exploit temporal locality, data that is least likely to be re-written soon is destaged, minimizing the total number of destages. This is normally achieved using a caching algorithm such as least recently written (LRW). Read caches have a small uniform cost of replacing any data in the cache, whereas the cost of write destaging depends on the state of the disk heads. Writes should destage in ways that minimize the average cost of each destage. For example, using a disk scheduling algorithm such as CSCAN, which destages data in the ascending order of the logical addresses, at the higher level of the write cache in a storage controller. LRW and CSCAN respectively exploit temporal and spatial locality, but not in combination.

A number of hard disks in storage controllers suffer from “dropped writes”. A condition when a write request to a disk is returned as successful, without the data actually being written correctly on the disk. This can happen due to a failure of a write channel on the disk, writing the data on the wrong track, or not having enough head current to magnetically write the data on the disk.

The probabilities of dropped writes are rare, but such disk errors can lead to data corruptions that go undetected for a long time. Dropped writes can be worse than data loss, and is like data corruption that will only be detected the first time it is requested. Once detected, the correct data can be recovered with error correction or brought in from backups.

Very critical applications cannot tolerate undetected dropped writes, so modern disks provide a write-with-verify command that reads back the written data immediately after the write operation to verify it. If the read data matches the written data, the write-with-verify will only then return success.

Such, however, is not a fool-proof solution. Write-with-verity will not detect if the data was written on a wrong track, or in between tracks, because it does not require repositioning of the head. It reads the data from the same position. Later, the head may seek the correct track, but of course the data will not be found.

The write-with-verify technique faces a severe read latency penalty. The read done to verify the written data has to wait a relatively long time for the disk platter to rotate full circle back to where the data was written. The disk throughput performance for writes can be degraded as much as 50%.

Many prior art methods have been suggested that make sure the head has had time to reposition itself properly. However, most of these are inefficient. They do not coordinate the verify/validation activity with the write activity to try to minimize any adverse impact on performance.

### SUMMARY OF THE PRESENT INVENTION

A write cache provides for staging of data units written from a processor for recording in a disk. The order in which destages and validations occur is controlled to make validations more efficient. The data units are arranged in a circular queue according to their respective disk storage addresses. Each data unit is tagged with a state value of 1, 0, or −1. A destaging pointer is advanced one-by-one to each data unit like the hand of a clock. Each data unit pointed to is evaluated as a destage victim. The first step is to check its state value. A data unit newly brought into the write cache will have its state value reset to 0. It will stay that way until it receives an overwrite x command or the destage pointer clocks around to x. If an overwrite x, the state value is set to 1, in a way, indicating recent use of the data unit and postponing its destaging and eviction. If the destage pointer clocks around to x when the state was 0, then it's time to destage x and the state value is changed to −1. A write to the disk occurs and a later read will be used to verify the write. If the state value was already 1 when the destage pointer clocks around to x, the state value is reset to 0. If the destage pointer clocks around to x when the state is −1, the associated data is read from the disk and validated to be same as the copy in cache. If not, the destage of x is repeated, and the stale value remains as −1. Otherwise, if the associated read validation was successful, then data unit x is evicted from the write cache.

A write cache is provided that minimizes the delays associated with destaging data units that must be verified they were correctly written to disk. The write cache substitutes a more efficient write and verify process for a disk than its own write-with-verify command. A write cache method controls the order in which destages and validations occur to make the mechanism of validations more efficient. The delays associated with destaging data units from a write cache that must be verified they were correctly written to disk are minimized.

The above summary of the invention is not intended to represent each disclosed embodiment, or every aspect, of the invention. Other aspects and example embodiments are provided in the figures and the detailed description that follow.

### BRIEF DESCRIPTION OF THE DRAWINGS

The present invention may be more completely understood in consideration of the following detailed description of various embodiments of the invention in connection with the accompanying drawings, in which:

FIG. 1 is a functional block diagram of a write cache in a storage system embodiment of the present invention; and

FIG. 2 is a schematic diagram of a state machine useful in write cache, and storage system embodiments of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

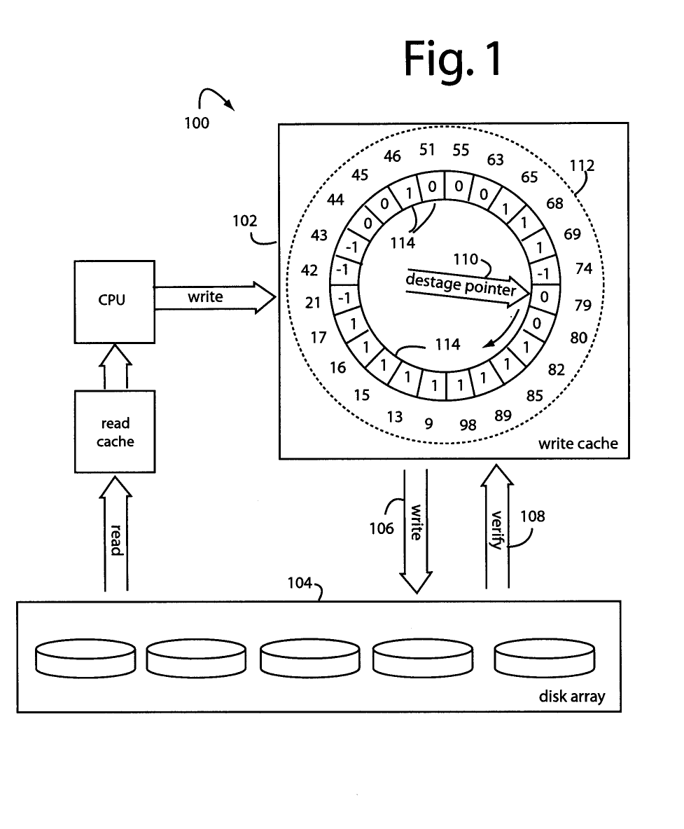

FIG. 1 represents a storage system embodiment, and is referred to herein by the general reference numeral 100. System 100 includes a write cache 102 that supports a disk array 104. Any writes 106 caused by destaging data units in the write cache 102 are followed by a verify 108 to ensure the data was correctly recorded. The disk array 104 includes rotating magnetic media that inherently imposes access delays of data transfers while the rotating disks rotate to the correct position under the heads, and the heads seek the right tracks with a servo and settle sufficiently. A destaging pointer 110 looks for destage victims by advancing one-by-one around a circular queue to each staged data unit 112 in write cache 102. A data unit should not be destaged if it is marked as only recently having been written, and should not be removed from the cache if it has not yet been verified as having been written correctly to disk.

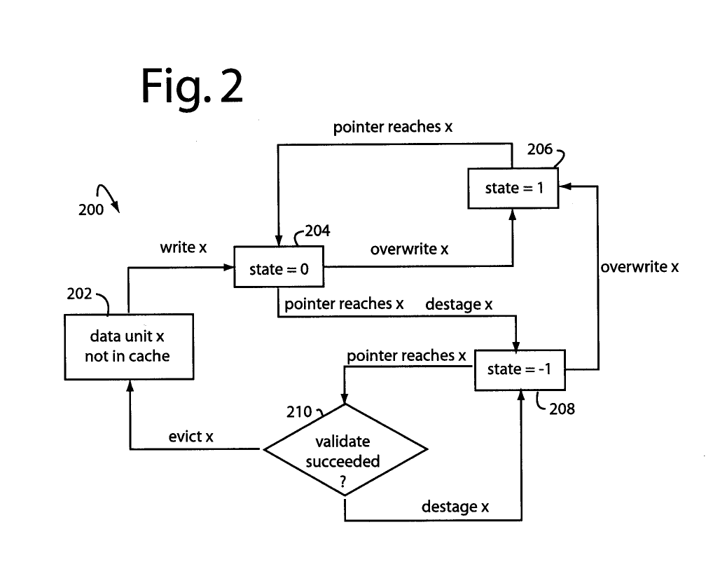

Destaging pointer 110 is used to queue the staged data units 112 for an operation that depends on a state value 114 that can be set to 1, 0, or −1. FIG. 2 represents a state machine 200 to implement this decision and action process. In one sense, state values 114 are a kind of recency bit, as described by one of the present inventors, Binny S. Gill, et al., WOW: Wise Ordering for Writes—Combining Spatial and Temporal Locality in Non-Volatile Caches, in FAST '05: 4th USENIX Conference on File and Storage Technologies, USENIX Association, pp. 129-142.

When a data unit is inserted into write cache 102, its associated state value 114 is reset to a value of 0. On a write hit, such value is set to 1. If verification is pending, state value 114 is set to −1, and when validation succeeds, the data unit is evicted from staged data units 112.

Embodiments of the invention therefore control the order in which write cache destages and validations occur, so as to make the validations more efficient. Such order also takes into account how near the data unit is recorded on the disk to where the heads are presently (spatial locality), and how soon they can be accessed (temporal locality).

Here, spatial locality (location) is an assumption that writing to locations with addresses numerically close together is more efficient. Temporal locality (time) assumes locations of a disk that were referenced recently tend to be referred to again soon.

Table-1 is an example provided to illustrate how write cache 102 operates. Twenty-four slots are available for staged data units 112, e.g., those with addresses, 9, 13, . . . , 89, 98. Each has associated with it a state 114 that can be set to 1, 0, or −1. The pointer in Table-1 is pointing like the one in FIG. 1 to show the correspondence. Such pointer will advance down to the bottom right, which is currently staging data unit address 98, and then return to the top left, which is shown here as staging data unit address 9 in write cache 102.

TABLE I

| data unit | | | data unit | |
|---|---|---|---|---|
| address | state | | address | state |
| 9 | 1 | | 55 | 0 |
| 13 | 1 | | 63 | 0 |
| 15 | 1 | | 65 | 1 |
| 16 | 1 | | 68 | 1 |
| 17 | 1 | | 69 | 1 |
| 21 | −1 | | 74 | −1 |
| 42 | −1 | pointer---> | 79 | 0 |
| 43 | −1 | | 80 | 0 |
| 44 | 0 | | 82 | 1 |
| 45 | 0 | | 85 | 1 |
| 46 | 1 | | 89 | 1 |
| 51 | 0 | | 98 | 1 |

FIG. 2 represents a state machine 200, and a circulating destage pointer 201 that rotates (conceptually, clockwise as in FIG. 1) looking for destage victims. A preferred destage victim is a data unit that hasn't been written recently and can be verified as recorded properly to disk. The action begins with a condition 202, in which a data unit x is not in cache. When a write to data unit x condition occurs, a transition is made to state 204, which sets STATE=0, meaning the data unit x was recently written. If an overwrite data unit x condition occurs, aka a write “hit”, a transition is made to a state 206, which sets STATE=1. It will wait in this state until the destage pointer advances to data unit x, and then transition to state 204, resetting STATE=0. If the destage pointer reaches data unit x with STATE=0, a destage of data unit x occurs, and a transition is made to a state 208, setting STATE=−1. If an overwrite data unit x condition occurs, a transition is made to state 206. STATE=1. Otherwise, when the destage pointer reaches data unit x, a test 210 checks to see if the validation succeeded, e.g., the data read back from the disk matched what had been written. If not, a destage of data unit x occurs and transition is made back to state 208. STATE=−1. Otherwise, if the validation succeeded in test 210, then data unit x is evicted and transitions to starting condition 202.

The state machine 200 ensures that any temporal locality advantages are leveraged for all writes. Any validates needed in the same regions as destages, are co-scheduled with the destages. Exploiting such spatial locality has been observed as being able to improve overall system performance.

The conventional use of a write cache to facilitate the detection and recovery of dropped writes is improved by embodiments of the invention. All writes and their subsequent validations are organized, scheduled, and controlled. The write verifications can mix in with the disk reading or writing, and are coordinated to minimize the impact of the validations on overall system performance.

Wise ordering for writes (WOW) is an algorithm for efficient writes by leveraging temporal locality in workloads and spatial locality on the disks adaptively. Here is provided an extension of the WOW algorithm. Such will provide efficient writes, and efficient verifications of the writes to guarantee detection and recovery from dropped writes.

WOW is a hybrid of least recently written (LRW) or one bit approximation and circular list (CLOCK), and the circular variant of the “elevator algorithm”, SCAN, (CSCAN). WOW is akin to CSCAN, because it destages in essentially the same order as CSCAN. However, WOW is different from CSCAN in that it skips destage of data that have been recently written to in the hope that that it is likely to be written to again. WOW generally will have a higher hit ratio than CSCAN at the cost of an increased gap between consecutive destages. WOW is like LRW in that it defers writes that have been recently written. Similarly, WOW is akin to CLOCK in that upon a write hit to a page a new life is granted to it until the destage pointer returns to it again. WOW is different from CLOCK in that the new writes are not inserted immediately behind the destage pointer as CLOCK would but rather in their sorted location. Thus, initially, CLOCK would always grant one full life to each newly inserted page, whereas WOW grants on an average half that much time. WOW generally will have a significantly smaller gap between consecutive destages than LRW, at the cost of a generally lower hit ratio.

One aspect of temporal locality is the time which a newly written page is allowed to linger in the cache without its producing a hit. For simplicity, the initial value of the recency bit is set to 0. On average, a new page gets a life equal to the time required by the destage pointer to go halfway around the clock. If during this time, it produces a hit, it is granted one more life until the destage pointer returns to it once again. If the initial value is set to 1, then, on an average, a newly written page gets a life equal to 1.5 times the time required by the destage pointer to go around the clock once. More temporal locality can be discovered if the initial life is longer, at the cost of larger average seek distances as more pages are skipped by the destage head. It may be possible to obtain the same effect without the penalty by maintaining a history of destaged pages, in a manner resembling multi-queue replacement policy (MQ), adaptive replacement cache (ARC), and CLOCK with adaptive replacement (CAR) algorithms.

In a method embodiment of the invention, a write cache provides for staging of data units written from a processor for recording in a disk. The order in which destages and validations occur is controlled to make validations more efficient. The data units are arranged in a circular queue according to their respective disk storage addresses. Each data unit x is tagged with a state value of 1.0, or −1. A destaging pointer is advanced one-by-one to each data unit x, like the hand of a clock. Each data unit x pointed to is evaluated as a destage victim. The first step is to check its state value. A data unit x newly brought into the write cache will have its state value reset to 0. It will stay that way until it receives an overwrite x command, or the destage pointer clocks around to x. If an overwrite x, the state value is set to 1, indicating recent use of the data unit x and postponing its destaging and eviction. If the destage pointer clocks around to x when the state was 0, then it's time to destage x, and the state value is changed to −1. A write to the disk occurs and a later read will be used to verify the write. If the state value was already 1 when the destage pointer clocks around to x, the state value is reset to 0. If the destage pointer clocks around to x when the state is −1, a test sees if the associated read for validation returned success. If not, the destage of x is repeated, and the state value remains as −1. Otherwise, if the associated read for validation did return a success, then data unit x is evicted from the write cache.

While the invention has been described with reference to several particular example embodiments, those skilled in the art will recognize that many changes may be made thereto without departing from the spirit and scope of the invention, which is set forth in the following claims.

1. A write cache providing for staging of data units written from a processor for recording in a disk, comprising:
a controller that arranges the order in which destages and validations of data units x occur so as to make validations more efficient.

2. The write cache of claim 1, further comprising:
a circular queue providing for the arrangement of a plurality of data units x according to their respective disk storage addresses.

3. The write cache of claim 2, further comprising:
a tag associated with each one of the plurality of data units x in the circular queue and providing for a state value of 1, 0, or −1.

4. The write cache of claim 1, further comprising:
a destaging pointer that can be advanced one-by-one to each data unit x like the hand of a clock, wherein each data unit x pointed to is evaluated as a destage victim.

5. The write cache of claim 4, further comprising:
a mechanism for checking the state value of each data unit x as selected by the destaging pointer, wherein each data unit x newly brought into the write cache will have its state value reset to 0.

6. The write cache of claim 5, further comprising:
a mechanism for operating when said state value is 0 that will wait until the first of either an overwrite x command is received, or the destage pointer clocks around to data unit x;
wherein, if an overwrite x command is received first, it will set the state value to 1 as an indication of recent use of the data unit x and for postponing its destaging and eviction;
wherein, if the destage pointer clocks around to data unit x first, then destaging data unit x and setting the state value to −1, such that a write to the disk occurs and a later read can be used to verify the write.

7. The write cache of claim 5, further comprising:
a mechanism for operating when said state value is 1, and that will wait until the destage pointer clocks around to data unit x, and then reset the state value to 0.

8. The write cache of claim 5, further comprising:
a mechanism for operating when said state value is −1, and that will wait until the first of either an overwrite x command is received, or the destage pointer clocks around to data unit x;
wherein, if an overwrite x command is received first, it will set the state value to 1 as an indication of recent use of the data unit x, and provide for postponing its destaging and eviction;
wherein, if the destage pointer clocks around to data unit x first, then performing the validation and checking to see if the validation succeeded, and if so, evicting data unit x, otherwise destaging data unit x again and remarking the state value to −1 to wait again for the destage pointer to clock around to data unit x.

9. A write cache providing for staging of data units written from a processor for recording in a disk, comprising:
a controller that arranges the order in which destages and validations of data units x occur so as to make validations more efficient;
a circular queue providing for the arrangement of a plurality of data units x in order of their respective disk storage addresses;
a tag associated with each one of the plurality of data units x in the circular queue and providing for a state value of 1, 0, or −1;
a destaging pointer that can be advanced one-by-one to each data unit x like the hand of a clock, wherein each data unit x pointed to is evaluated as a destage victim;
a mechanism for checking the state value of each data unit x as selected by the destaging pointer, wherein each data unit x newly brought into the write cache will have its state value reset to 0;
a mechanism for operating when said state value is 0 that will wait until the first of either an overwrite x command is received, or the destage pointer clocks around to data unit x;
wherein, if an overwrite x command is received first, it will set the state value to 1 as an indication of recent use of the data unit x and for postponing its destaging and eviction;
wherein, if the destage pointer clocks around to data unit x first, then destaging data unit x and setting the state value to −1, such that a write to the disk occurs and a later read can be used to verily the write;
a mechanism for operating when said state value is 1, and that will wait until the destage pointer clocks around to data unit x, and then reset the state value to 0;
a mechanism for operating when said state value is −1, and that will wait until the first of either an overwrite x command is received, or the destage pointer clocks around to data unit x;
wherein, if an overwrite x command is received first, it will set the state value to 1 as an indication of recent use of the data unit x, and provide for postponing its destaging and eviction;
wherein, if the destage pointer clocks around to data unit x first, then performing the validation and checking to see if the validation succeeded, and if so, evicting data unit x, otherwise destaging data unit x again and remarking the state value to −1 to wait again for the destage pointer to clock around to data unit x.

10. A write cache method providing for staging of data units written from a processor for recording in a disk, comprising:
arranging the order in which destages and validations of data units x staged in a disk write cache occur so as to make validations more efficient.

11. The write cache method of claim 10, further comprising:
providing a circular queue for the arrangement of a plurality of data units x according to their respective disk storage addresses.

12. The write cache method of claim 11, further comprising:
associating a tag with each one of the plurality of data units x in the circular queue and providing for a state value of 1, 0, or −1.

13. The write cache method of claim 10, further comprising:
advancing a destaging pointer one-by-one to each data unit x like the hand of a clock, wherein each data unit x pointed to is evaluated as a destage victim.

14. The write cache method of claim 13, further comprising:
checking the state value of each data unit x as selected by the destaging pointer, wherein each data unit x newly brought into the write cache will have its state value reset to 0.

15. The write cache method of claim 14, further comprising:
a mechanism for operating when said state value is 0 that will wait until the first of either an overwrite x command is received, or the destage pointer clocks around to data unit x;
wherein, if an overwrite x command is received first, it will set the state value to 1 as an indication of recent use of the data unit x and for postponing its destaging and eviction;
wherein, if the destage pointer clocks around to data unit x first, then destaging data unit x and setting the state value to −1, such that a write to the disk occurs and a later read can be used to verify the write.

16. The write cache method of claim 14, further comprising:
operating when said state value is 1, and that will wait until the destage pointer clocks around to data unit x, and then reset the state value to 0.

17. The write cache method of claim 14, further comprising:
operating when said state value is −1, and that will wait until the first of either an overwrite x command is received, or the destage pointer clocks around to data unit x;
wherein, if an overwrite x command is received first, it will set the state value to 1 as an indication of recent use of the data unit x, and provide for postponing its destaging and eviction;
wherein, if the destage pointer clocks around to data unit x first, then performing a validation and checking to see if the validation succeeded, and if so, evicting data unit x, otherwise destaging data unit x again and remarking the state value to −1 to wait again for the destage pointer to clock around to data unit x.

18. A write cache method providing for staging of data units written from a processor for recording in a disk, comprising:
arranging the order in which destages and validations of data units x occur so as to make validations more efficient;
providing a circular queue for the arrangement of a plurality of data units x in order of their respective disk storage addresses;
associating a tag with each one of the plurality of data units x in the circular queue and providing for a state value of 1, 0, or −1;
advancing a destaging pointer one-by-one to each data unit x like the hand of a clock, wherein each data unit x pointed to is evaluated as a destage victim;
checking the state value of each data unit x as selected by the destaging pointer, wherein each data unit x newly brought into the write cache will have its state value reset to 0;
operating when said state value is 0 that will wait until the first of either an overwrite x command is received, or the destage pointer clocks around to data unit x, wherein, if an overwrite x command is received first, it will set the state value to 1 as an indication of recent use of the data unit x and for postponing its destaging and eviction, and wherein, if the destage pointer clocks around to data unit x first, then destaging data unit x and setting the state value to −1, such that a write to the disk occurs and a later read can be used to verily the write;
operating when said state value is 1, that will wait until the destage pointer clocks around to data unit x, and then reset the state value to 0;
operating when said state value is −1, that will wait until the first of either an overwrite x command is received, or the destage pointer clocks around to data unit x, wherein, if an overwrite x command is received first, it will set the state value to 1 as an indication of recent use of the data unit x, and provide for postponing its destaging and eviction, and wherein, if the destage pointer clocks around to data unit x first, then performing a validation and checking to see if the validation succeeded, and if so, evicting data unit x, otherwise destaging data unit x again and remarking the state value to −1 to wait again for the destage pointer to clock around to data unit x.

19. A disk storage system, comprising:
a write cache in which write data may be staged, verified, and destaged;
a plurality of disks in an array supported by the write cache;
a place for modified data to reside in the write cache while data is written to a disk and later verified to be correctly written before being destaged;
wherein, destages and validations are ordered by addresses to make validations more efficient.

20. The system of claim 19, further comprising:
a WOW algorithm that provides for efficient writes by leveraging temporal locality in workloads and spatial locality on the disks adaptively;
wherein is provided efficient writes, and efficient verifications of such writes, and provided detection of any dropped writes, and any corresponding data recovery.

21. The system of claim 19, further comprising:
a head-to-tail circular list of data units sorted by their addresses on disk, wherein each data unit stores a state value of −1, 0, or 1; and
a circulation pointer that rotates around the circular list that selects a data unit data unit x for examination of its associated state value;
wherein, temporal locality is leveraged for all writes, and validate and concurrent destages happen in the same region of the disk, thus improving overall performance of the system by leveraging spatial locality.
